(19) United States
(12) Patent Application Publication
(10) Pub. No.: US 2020/0115923 A1
(43) Pub. Date: Apr. 16, 2020

(54) APPLIANCE LOCK WITH REPELLING MAGNETIC SENSING SWITCH ACTUATION IN A HYDROPHOBIC ENCLOSURE

(71) Applicant: HTI Technology and Industries, Inc., La Vergne, TN (US)

(72) Inventors: Roger DeYoung, Franklin, TN (US); I-Chiang Lin, San Marino, CA (US)

(73) Assignee: HTI Technology and Industries, Inc., La Vergne, TN (US)

(21) Appl. No.: 16/688,093

(22) Filed: Nov. 19, 2019

Related U.S. Application Data
(63) Continuation-in-part of application No. 16/654,140, filed on Oct. 16, 2019.
(60) Provisional application No. 62/746,276, filed on Oct. 16, 2018.

(51) Int. Cl. E05B 17/00; E05B 17/22

(52) U.S. Cl. CPC E05B 17/0062; E05B 17/22; E05Y 2900/312; E05Y 2900/304; E05Y 2900/30

(57) ABSTRACT

Provided is a locking mechanism for a consumer appliance comprising a lid or door position sensing feature incorporating two magnets in a repelling relationship. One magnet is incorporated into a lid pawl and the other magnet is incorporated into a switch actuating component inside of the locking mechanism such that their like poles are facing each other to repel each other when the pawl is moved into the actuation zone of the locking mechanism. By nature, magnets tend to seek attraction alignment, therefore a repelling alignment is contrary to the natural tendency of magnets. Structural rigidity is required in the locking mechanism to hold the magnets in the repelling state. Consequently, it is not easy or intuitive for a user to defeat this sensing method with another magnet.

### CROSS-REFERENCE TO RELATED APPLICATIONS

This application is a Continuation-In-Part of U.S. Ser. No. 16/654,140, entitled APPLIANCE LOCK WITH MAGNETIC SENSING SWITCH ACTUATION IN A HYDROPHOBIC ENCLOSURE, filed Oct. 16, 2019, which claims the benefit of U.S. Provisional Application No. 62/746,276, entitled APPLIANCE LOCK WITH MAGNETIC SENSING SWITCH ACTUATION IN A HYDROPHOBIC ENCLOSURE, filed Oct. 16, 2018, both of which are fully incorporated herein by reference.

### TECHNICAL FIELD

The present disclosure pertains to the art of locking mechanisms, in particular, locking mechanisms, used in combination with various types of appliances. Specifically disclosed herein is a solenoid module locking device including various features, such as position detection capabilities and hydrophobic properties.

### BACKGROUND

Powered appliances such as washing machines and dish washers incorporate an electrically powered lid lock or door lock that is controlled by the appliance's electronic controller. These lock mechanisms generally incorporate either a solenoid or an electric motor to convert electrical power into linear motion, which can then be used to engage the locking features of the lock mechanism with a corresponding locking feature of the appliance's lid or door. The purpose for locking an appliance lid or door is to preclude operation of certain functions of the appliance when the lid or door is placed in an open position, as well as to prevent accidental contact with moving parts in the appliance in the event that a user opens the lid or door during normal appliance operation.

These lock mechanisms incorporate a lid or door position sensing feature that is actuated by the closing of the appliance's lid or door. Three known electrical components are used for this sensing feature: 1) a switch that is mechanically actuated; 2) a reed switch that is actuated by a magnet; and 3) a Hall Effect sensor, which is also actuated by a magnet. Most manufacturers use a switch that is mechanically actuated because this type of switch can withstand greater electrical loads (such as, but not limited to, the line voltage supplied by the utility power grid), whereas reed switches and Hall Effect sensors require additional electrical components to reduce voltage and/or current. The addition of these electrical components is both costly and complex. However, one benefit of reed switches and Hall Effect sensors is that they are inherently hydrophobically sealed. This is advantageous in moist or wet environments, such as washing machines and dish washers.

In contrast, switches that are mechanically actuated require partial enclosure of the switch to prevent the switch from over-exposure to water, moisture, or steam. However, this type of enclosure does not completely seal the switch off from water, moisture, and steam because the sliding portions of the device require openings in the enclosure for engagement with the locking features of the lid or door. Further, the mechanical contact that is needed to actuate the sensing switch of the lid or door results in objectionable clicking and sliding noises from the sensing portion of the locking mechanism. Regardless of the type of sensor, these components communicate an open-circuit or closed-circuit state to the appliance's controller. The open-circuit or closed-circuit states are interpreted by the programmed logic of the controller before allowing commencement of the functions of the appliance. For user safety, the appliance will prevent certain functions from working unless the lid or door is closed and locked.

Inside nearly all known lock mechanisms is a secondary lock sensing switch which senses the position of the locking features of the lock mechanism. This lock sensing switch also communicates with the open-circuit or closed-circuit states of the appliance's controller. The states of both sensing circuits are interpreted by the programmed logic of the controller. The locking function is activated by the appliance's controller when the user selects specific functions. The lock will activate only if the lid or door sensing switch is actuated. As the appliance's controller activates the lock, the lock sensing switch button will actuate and signal the appliance's controller to proceed with its intended functions, allowing for safe operation of the appliance.

In the current art, there are multiple known methods of actuating lid or door sensors. Actuation of reed switch sensors and Hall Effect sensors is simply done with a magnet affixed to a lid or door such that when the lid or door is closed, the magnet comes within close proximity to the sensor, thereby actuating the sensor. Regarding a switch that is mechanically actuated, there are two known methods of actuation. The first method of switch actuation is made by a finger, protruding from the appliance's lid or door, that makes physical contact with the switch button and actuates this button as the lid or door travels to a closed position. The second method of switch actuation is made by a finger, protruding from the appliance's lid or door, that contacts a cam or plunger. As the finger engages the cam or plunger, it produces a sliding linear motion on the cam or plunger as the door closes. This sliding motion allows the cam or plunger to make physical contact with the switch button and thus actuate the button as the lid or door travels to a closed position.

An additional safety requirement for certain types of appliances, most notably washing machines and dishwashers, is for the user to be able to force open the locking mechanism by applying an excessive amount of opening force to the lid or door. This “force open” feature is intended to allow a trapped person or pet to escape the appliance after a function has been initiated. Once the appliance is subjected to such a force open event, the door latch sensing switch will signal to the controller an open-circuit state, thereby shutting off the appliance. If the lid or door lock is damaged because of a force open event, the lock sensing switch circuit and/or the lid or door sensing switch circuit must be incapacitated so that it cannot send a closed-circuit status to the controller, thus precluding the controller from activating appliance functions until repairs are made. Some manufactures accomplish this by incorporating a component in the latch that is designed to catastrophically fail upon the happening of a force open event. Consequently, the owner of the appliance cannot use the appliance again, following a force open event, until expensive repairs are made.

In the above described methods of locking appliance doors, clear issues exist with each of these technologies. Reed switch sensors and Hall Effect sensors are hydrophobically sealed but these methods are expensive due to the need for additional components. Mechanically actuated sensing switches are cost effective and can carry high electrical power, but they are not hydrophobically sealed. Locking mechanisms that have intentional fail-safe features in order to provide for a force open function in the event of someone (or something) becoming trapped inside the appliance are an inconvenient and unexpected expense for the appliance owner. What is needed is an appliance locking mechanism that is cost effective, quiet, high-voltage compatible, hydrophobically sealed, and which does not require a repair after the occurrence of a force open event.

In another aspect, in locking mechanisms for lids or doors of home appliances, it is necessary for the appliance controller to sense when the lid or door is in a closed position prior to the controller sending a command to the locking mechanism to actuate the lock. Typically, a switch in the lock mechanism is actuated by a door feature such as a pawl affixed to the door or lid. As the door or lid is closed, the pawl (via magnetic attraction or via mechanical action) will influence a switch actuating component within the locking mechanism. In the case of magnetic attraction, two common methods of actuation are known: 1) a magnet in the pawl will attract a second magnet within the actuating component to mechanically depress a switch button to complete the signal circuit; and 2) a magnet in the pawl will attract a ferrous member within a reed switch to complete the signal circuit. In the case of the mechanical action, the pawl, as the lid or door moves to a closed position, will contact a switch actuating component causing it to slide or pivot and thus actuate a switch or switching contacts.

There are disadvantages to the above-mentioned methods of actuating lid or door position sensing switches. In the case of a magnetic attraction relationship, the sensing function can be defeated by inserting another magnet into the zone of attraction to cause the switch actuating component or reed switch to be actuated and thus complete the circuit signal to the appliance controller. This would render the appliance operable with the lid or door in an open position. In the case of the mechanical actuation, the sensing function can be defeated by inserting a wedge to prop the slide or pivot in an actuated position. These methods of defeating the lock are intuitive to end users of appliances. What is needed is a sensing switch actuation method that is not intuitive and therefore more difficult to defeat.

### SUMMARY

The present disclosure addresses all of the previously presented needs in the art by way of a locking mechanism incorporating a cost-effective, non-contact lid or door sensing switch that is housed in a hydrophobically sealed enclosure. The lid or door position sensing feature is quiet in operation. The lid or door position sensing switch and the lock position sensing switch both carry high electrical power without the need for additional electrical components. The design also incorporates a spring-loaded lid or door pawl that protects the pawl or latch from catastrophic failure from a force open event while also precluding the lid or door from reclosing after the occurrence of such an event, thus requiring either the user (or a technician) to reset the controller functions.

Additional multiple methods have been developed for lid or door position sensing for a consumer washing machine, which have been described in the current application. An additional lid or door position sensing feature incorporates the use of two magnets in a repelling relationship; that is, like poles set in a facing arrangement to effect magnetic repulsion, either north-to-north or south-to-south magnetic poles. In such a configuration, one magnet is incorporated into the pawl and the other magnet incorporated into a switch actuating component inside of the locking mechanism such that their like poles are facing each other. The like poles of the respective magnets are aligned in a facing arrangement to repel each other when the pawl is moved into the actuation zone of the locking mechanism. By nature, magnets tend to seek attraction alignment, therefore a repelling alignment is contrary to the natural tendency of magnets. Structural rigidity is required in the locking mechanism to hold the magnets in the repelling state. Consequently, it is not easy or intuitive for a user to defeat this sensing method with another magnet.

Still other benefits and advantages of the appliance lock disclosed herein will become apparent to those skilled in the art to which it pertains upon a reading and understanding of the following detailed specification.

### BRIEF DESCRIPTION OF THE DRAWINGS

The appliance lock disclosed herein may take physical form in certain parts and arrangement of parts, embodiments of which will be described in detail in this specification and illustrated in the accompanying drawings which form a part hereof and wherein:

FIG. 1 is a perspective view of a pawl mechanism, showing the internal workings thereof;

FIG. 2 is a perspective view of a housing assembly and a bezel associated therewith;

FIG. 3 is a perspective view showing the housing assembly with the bezel attached thereto;

FIG. 4 is a perspective view showing a lock cover when separated from a lock mechanism;

FIG. 5 is an exploded view of the internal workings of the lock mechanism;

FIG. 6 is a perspective view of the housing assembly with the bezel attached thereto, accompanied by the pawl mechanism;

FIG. 7 shows the locking pin in a retracted, or unlocked, position;

FIG. 8 shows the locking pin in an extended, or locked, position;

FIG. 9 is a side view showing the interaction between the pawl arm and the locking pin;

FIG. 10 is a side view of the pawl arm during a force open event;

FIG. 11 is an inverted isometric view of the pawl arm interacting with the locking pin when in an extended, or locked, position;

FIG. 12 is an inverted isometric view of the pawl arm interacting with the locking pin when in an extended, or locked, position;

FIG. 13 is an alternative view of the pawl mechanism;

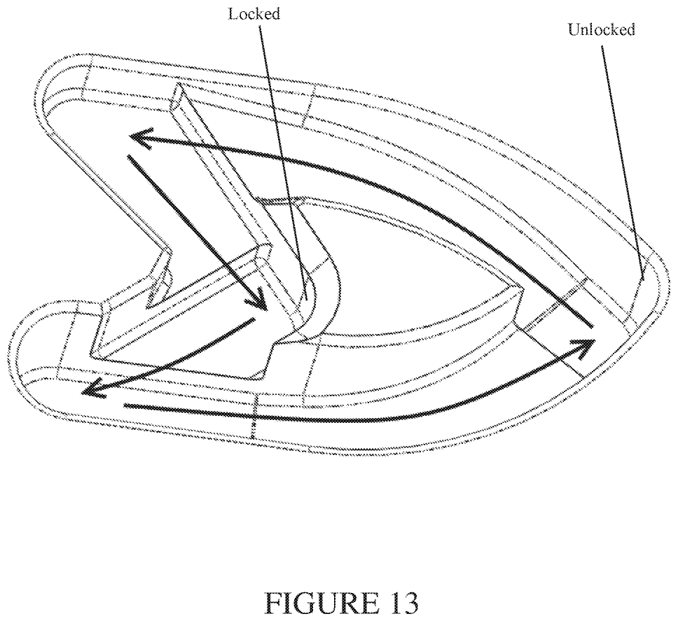

FIG. 14 is a view of the lid pawl assembly in accordance with an alternative embodiment;

FIG. 15 is a view of the lid pawl assembly with the lid pawl in a broken condition caused by a forced open lid event;

FIG. 16 is an exploded view of lid pawl assembly components;

FIG. 17 is an exploded view of the lid lock assembly, the mounting bezel, and the lid pawl assembly;

FIG. 18 is an exploded view showing the mounting bezel snapped onto the lid lock assembly;

FIG. 19 is a view of the lid pawl assembly engaged with lid lock assembly;

FIG. 20 is a view of the lid pawl assembly in the forced open condition;

FIG. 21 is a view of the lid pawl assembly in the forced open condition indicating that the washing machine lid cannot be closed for operation;

FIG. 22 is an exploded view of lock assembly components;

FIG. 23 is a perspective view of the solenoid plunger and components;

FIG. 24 is a perspective phantom view of the plunger components and related components shown in the unlocked position;

FIG. 25 is a perspective phantom view of the plunger and related components shown in the locked position;

FIG. 26 is a view of the lock housing showing pivotal motion of the locking toggle;

FIG. 27 is a view of the locking toggle with toggle pin in the unlocked state;

FIG. 28 is a view of the locking toggle with toggle pin transitioning to the locked state;

FIG. 29 is a view of the locking toggle with toggle pin in the locked state;

FIG. 30 is a view of the locking toggle with toggle pin transitioning to the unlocked state;

FIG. 31 is a view of the circuit board assembly;

FIG. 32 is a view of the circuit board assembly with the solenoid plunger in the unlocked position;

FIG. 33 is a view of the circuit board assembly with the solenoid plunger in the locked position;

FIG. 34 is a view of the components of the lock housing;

FIG. 35 is an exploded view of lock housing components;

FIG. 36 is an alignment illustration of the lock assembly and the pawl assembly;

FIG. 37 is a cut-away illustration of locking components in the locked position;

FIG. 38 is an electrical schematic showing circuit logic and symbolic references;

FIG. 39 is a detail view of the components of the switch actuator assembly;

FIG. 40 shows the interface of the lid pawl with the lid lock assembly;

FIG. 41 shows the interface of the lid pawl with the lid lock assembly in engagement with the lid switch;

FIG. 42 is a view of a circuit board and magnetic actuator in accordance with a further alternative embodiment;

FIG. 43 is a view of a lid pawl in accordance with the further alternate embodiment;

FIG. 44 shows the lid pawl broken in accordance with the further alternate embodiment;

FIG. 45 shows the interface of a lid pawl and a lock assembly with the further alternate embodiment; and

FIG. 46 shows the interface of a lid pawl and a lock assembly in engagement with the lid switch in the further alternate embodiment.

### DETAILED DESCRIPTION

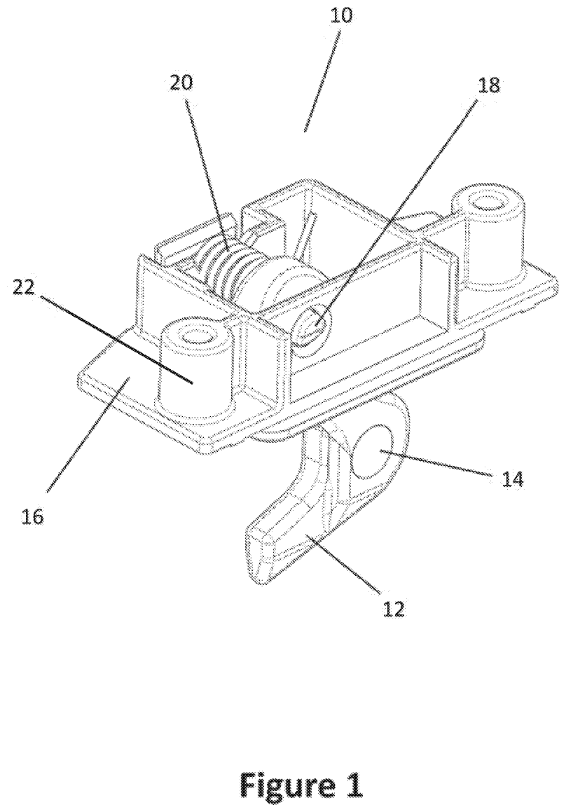

Referring now to the drawings wherein the showings are for purposes of illustrating embodiments of an appliance lock only and not for purposes of limiting the same, and wherein like reference numerals are understood to refer to like components, FIG. 1 shows a perspective view of a pawl mechanism 10 of an appliance lock which can be used in order lock various types of appliances. The pawl mechanism 10 is thus of such a nature and design that when inserted into a corresponding appliance locking mechanism, the pawl mechanism 10 restricts the movement of the lid, door, or other surface to which the pawl mechanism 10 is affixed to only that of a single direction of movement. In doing so, the pawl mechanism 10 acts as a latch between the lid, door, or other surface and that of the appliance itself.

With continued reference to FIG. 1, a pawl bracket 16 is comprised of a relatively flat surface which may be constructed so as to have a series of compartments thereon. According to the example as shown in FIG. 1, the top surface of the pawl bracket 16 contains a generally rectangular-type enclosure which is defined by approximately four sidewalls. Positioned about any different number of the approximately four sidewalls may be any different number of connection means 22. The connection means 22 of the example shown in FIG. 1 are that of a cylindrical receiver connector. This type of connection means 22 may receive a screw or other type of fastener so as to secure the pawl bracket 16 to that of a lid, door, or other surface so as to be used in the opening/closing procedure of the appliance.

Located on the underside of the pawl bracket 16 is a pawl arm 12. The pawl arm 12 is generally defined by a protruding arm-like structure which extends away from that of the pawl bracket 16. The pawl arm 12 may be of a generally circular nature at the point extending immediately beneath the pawl bracket 16, followed by a gradated curved portion which extends into a tab-like feature capable of being inserted into any different number of corresponding receivers. Approaching the end of the tab, as defined as that portion which is furthest away from that of the generally circular portion of the pawl arm 12, the tab may taper off such that the end of the tab is of a sufficient size so as to be received by the corresponding receiver.

With continued reference to FIG. 1, positioned about substantially the center of the generally circular portion of the pawl arm 12 is that of a pawl magnet 14. The pawl magnet 14 may be of any type of magnet as chosen by those having skill in the pertinent art. While the magnet as shown in FIG. 1 is of a circular nature, the geometric shape of the pawl magnet 14 may vary according to that of the corresponding receiver magnet contained within that of the locking mechanism, as will be described in greater detail below, or according to any other design criteria as identified by those having skill in the art.

Located within the rectangular-shaped enclosure positioned about the top of the pawl bracket 16 is a pawl pivot pin 18, surrounded by a pawl spring 20. The pawl spring 20 provides a means of allowing the pawl mechanism 10 to be involved in a force open event without subjecting the pawl mechanism 10 to a catastrophic failure. A force open event may occur, for example, when the associated appliance to which the pawl mechanism 10 is being used to secure is confronted with a situation in which the lid or door requires opening from the interior. Such a scenario requires the opening of the lid or door in the absence of following the typical protocol of releasing the locking mechanism, and thereby “forcing” the lid or door open.

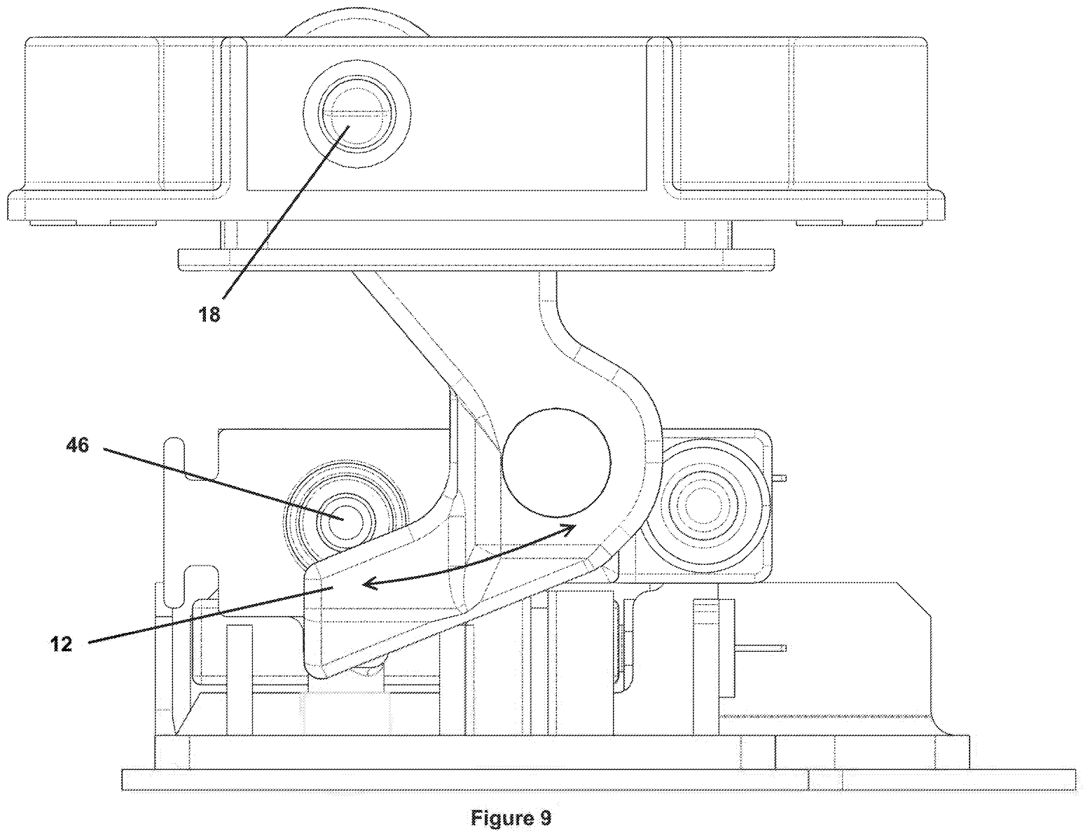

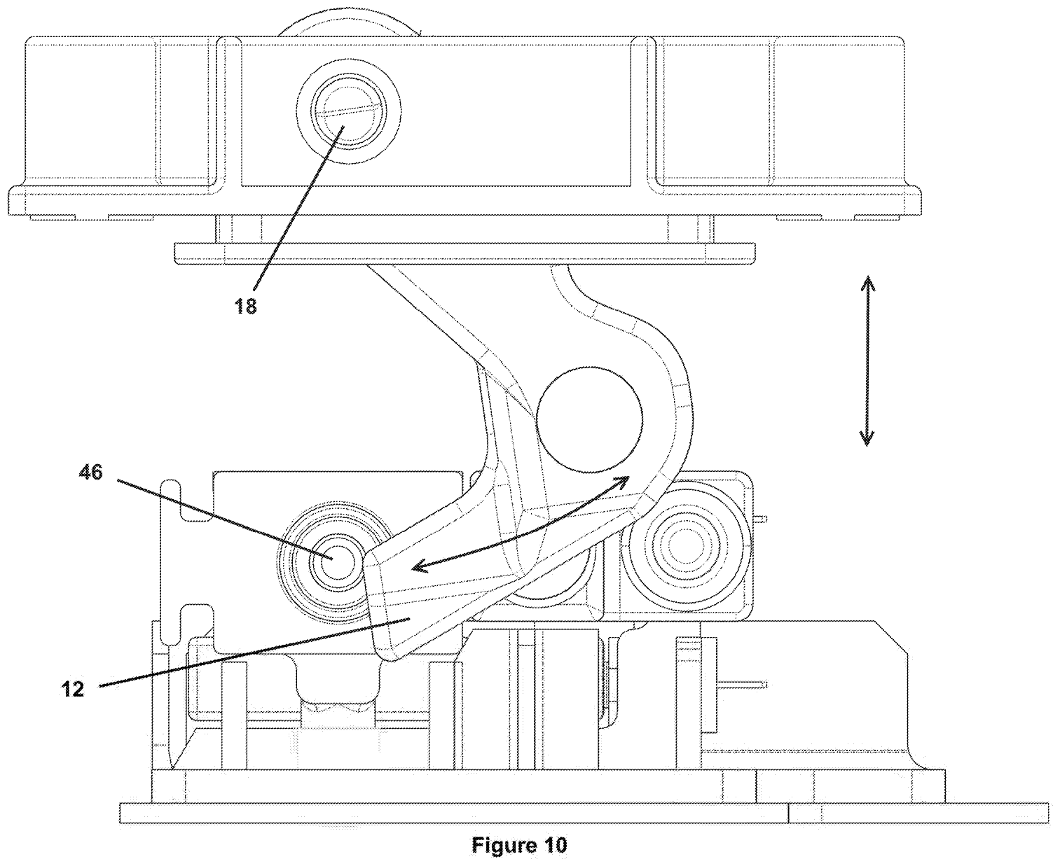

Turning now to FIGS. 9 and 10, the interaction of the pawl arm 12 and the locking pin 46 is shown during a force open event. With specific reference to FIG. 10, the rotational movement of the pawl arm 12 can be seen as the force to open event continues. The pawl spring 20 induces a torque on the pawl arm 12, causing a rotational pivot on the pawl pivot pin 18. The pawl spring 20 thus allows the pawl arm 12 to pivot and thereby release itself from the lock mechanism 40. The pawl arm 12 is restricted from rotating for any other functions. Returning now to FIG. 9, the natural position of the pawl arm 12 is shown. The angle of the pawl arm 12 with respect to the locking pin 46 allows the pawl arm 12 to move about in a rotational manner upon the application of force to the lid or door according to an opening function. The pawl spring 20 has a preset force that biases the pawl arm 12. The relationship of the angle and the pawl spring 20 requires a predetermined minimum force for opening the appliance lid or door.

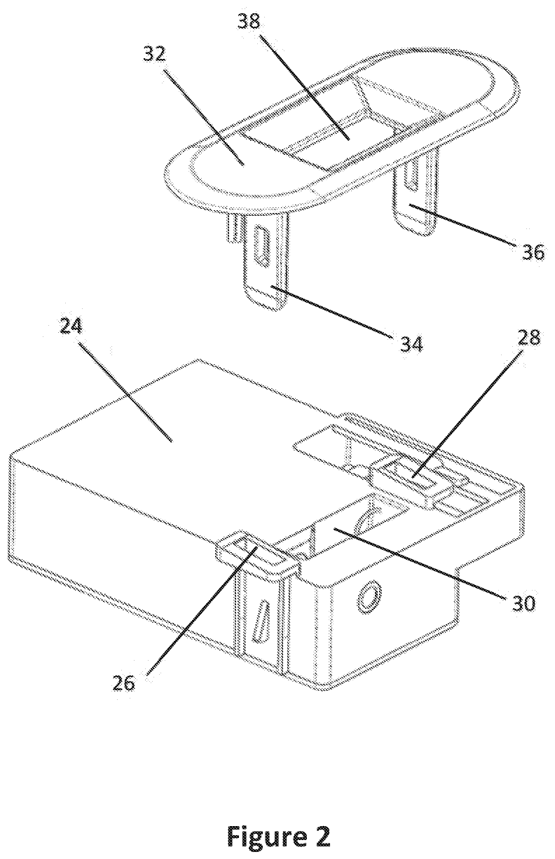

With reference now to FIG. 2, a housing assembly 24 of the appliance lock is shown. The housing assembly 24 may be used to cover that of the locking mechanism, as will be described in further detail below. The housing assembly 24 is thus generally defined by a geometric shape which corresponds to that of the locking mechanism. According to the embodiment shown in FIG. 2, the housing assembly 24 is of a generally rectangular design, with one of the width portions being further defined by an overhang portion which extends beyond that of the base region of the assembly. The presence of this overhang portion gives the housing assembly 24 an L-shaped, or staircase, appearance when viewed about the front face of the assembly. Positioned about opposing sides of the length of the housing assembly 24 are a first receiving slot 26 and a second receiving slot 28. Each of the respective receiving slots 26 and 28 may be generally rectangular in nature, defined by a hollow portion of the housing assembly 24, extending from the top portion of the housing assembly 24 to approximately the lower portion, or base. Located between the receiving slots 26 and 28 is a hollow cavity, or receiving channel 30. While occupying the space between that of the receiving slots 26 and 28, the receiving channel 30 does not share an opening with either respective receiving slot. The receiving slot 30 is generally rectangular in nature, having a depth approximately equal to that of the overall height of the housing assembly 24.

With continued reference to FIG. 2, a corresponding bezel 32 of the appliance lock is shown. The bezel 32 may have a generally rectangular shape, however the corners of the bezel 32 may be rounded or filleted so as to give the bezel 32 the appearance of an elongated oval. On the underside of the bezel 32 are two protruding structures, a first tab 34 and a second tab 36. Each of the first and second tabs 34 and 36 extend away from the face of the bezel 32, and may further have various types of securement means positioned about either of the various faces thereof. The spacing of the respective tabs is equivalent to that of the spacing of the respective receiving slots 26 and 28 located on the housing assembly 24. The bezel 32 may thus be inserted onto the face of the housing assembly 24 by way of inserting each of the first tab 34 and second tab 36 into that of the first receiving slot 26 and second receiving slot 28, respectively.

Positioned between that of the first and second tabs, 34 and 36, is that of a receiving channel slot 38. The receiving channel slot 38 has dimensions substantially similar to that of the receiving channel 30 located on the housing assembly 24. The receiving channel slot 38 may further be defined as a cutaway portion of the central region of the bezel 32, accompanied by a series of tapered edges extending away from the underside of the bezel 32. When the first tab 34 and second tab 36 are inserted into the respective receiving slots 26 and 28, the bezel 32 sits flush about the face of the housing assembly 24, with each of the receiving channel 30 and the receiving channel slot 38 aligning with one another so as to create a single, continuous opening.

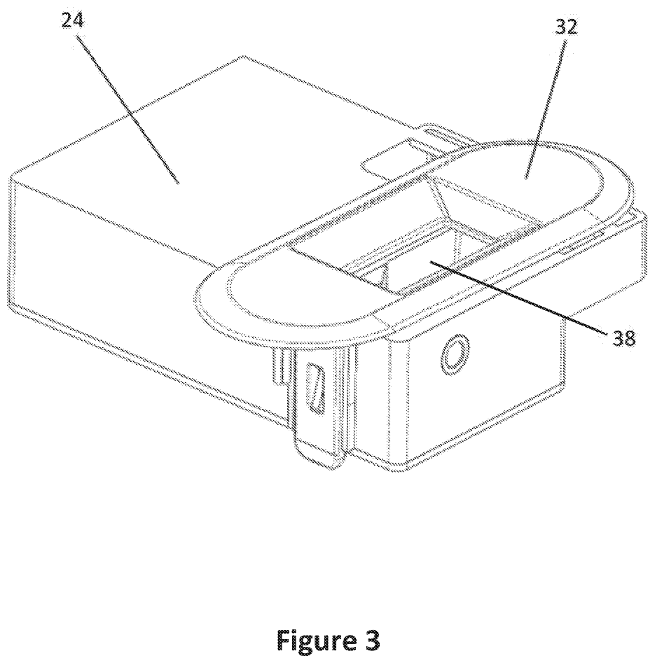

With reference now to FIG. 3, the bezel 32 is shown with each of the first tab 34 and second tab 36 inserted into the respective receiving slots 26 and 28. The single opening defined by each of the receiving channel 30 and receiving channel slot 38 may thus be seen.

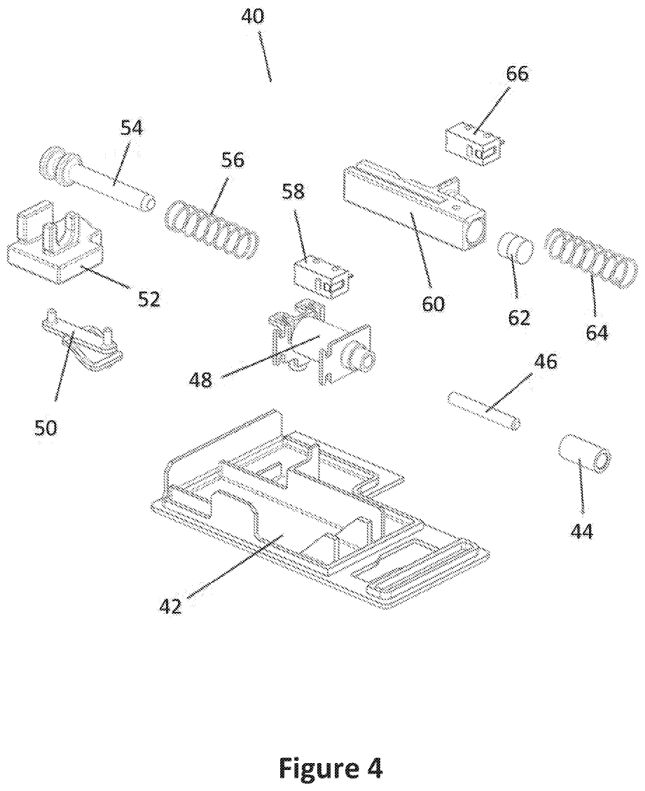

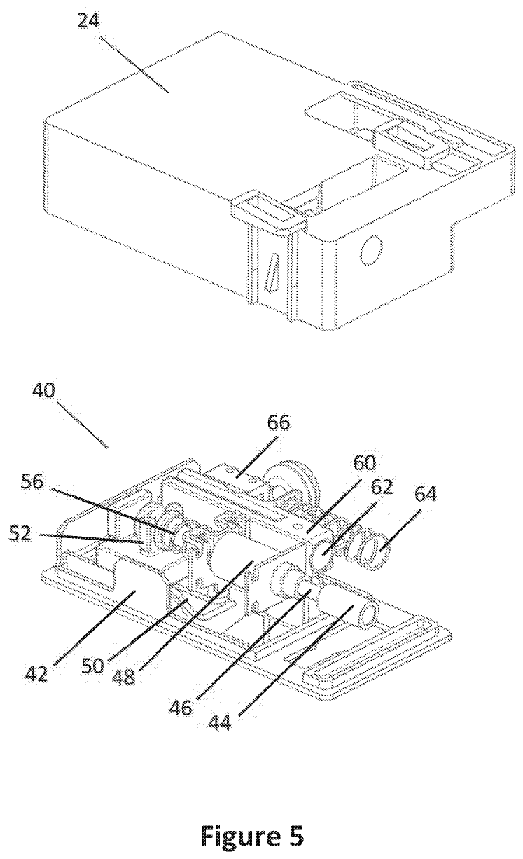

With reference to FIG. 4, the lock mechanism 40 of the appliance lock is shown in an exploded view, isolating each of the primary components of the mechanism. FIG. 5 illustrates the lock mechanism 40 of the appliance lock when fully assembled. The lock base 42 serves as a platform upon which each of the various components which comprise the lock mechanism 40 may rest. The lock base 42 is of a generally rectangular design. According to the embodiment shown in FIG. 4, the lock base 42 may have an additional panel which extrudes beyond that of the width of the front portion of the panel, creating an L-shaped appearance to the overall lock base 42. A series of compartmentalized features, consisting of dividers and other similar paneling, may extend up and away from that of the lock base 42.

According to the embodiment shown in FIGS. 4 and 5, the housing assembly 24 is seen in an elevated position above that of the lock mechanism 40, thus generally illustrating the manner in which the housing assembly 24 is positioned atop that of the lock mechanism 40. A solenoid 48 is positioned central to each of a solenoid plunger 54 to the rear and a locking pin 46 to the front. Surrounding the solenoid plunger 54 is that of a plunger spring 56. The plunger 54 is affixed to a labyrinth block 52. Located beneath the plunger 54 is a plunger cam 50. When the solenoid 48 is activated electrically, the plunger 54 is able to slide about a horizontal axis via the plunger cam 50. As the plunger 54 is confined by the labyrinth block 52, this sliding motion of the plunger 54 is limited to only that of a desired direction and distance. As the plunger 54 extends, this in turn causes the locking pin 46 to extend, as it is positioned about the opposing side of the solenoid 48. With the guide sleeve 44 affixed to the end of the locking pin 46, the extension of the locking pin 46 thus causes the lock mechanism to be placed in the locked, or “closed-circuit” position.

With continued reference to FIG. 5, a lid sensor slide 60 is shown. Connected about one end of the lid sensor slide 60 is a lid sensor magnet 62. The lid sensor magnet 62, as shown in the embodiment of FIG. 5, is circular in design. A person having ordinary skill in the art will appreciate that various types and geometric shapes of magnets may be used.

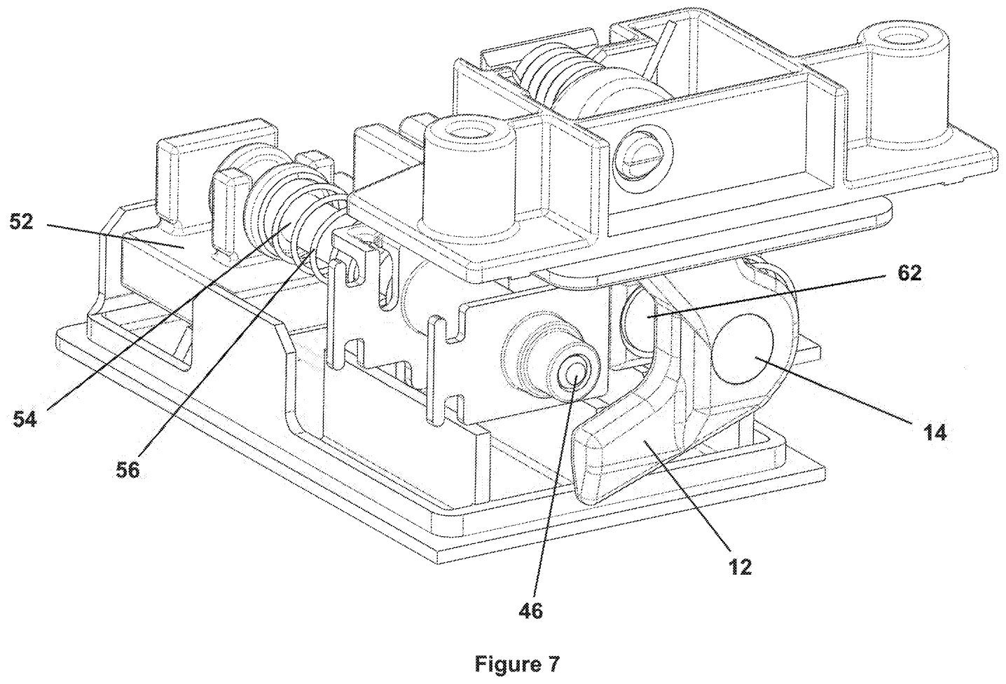

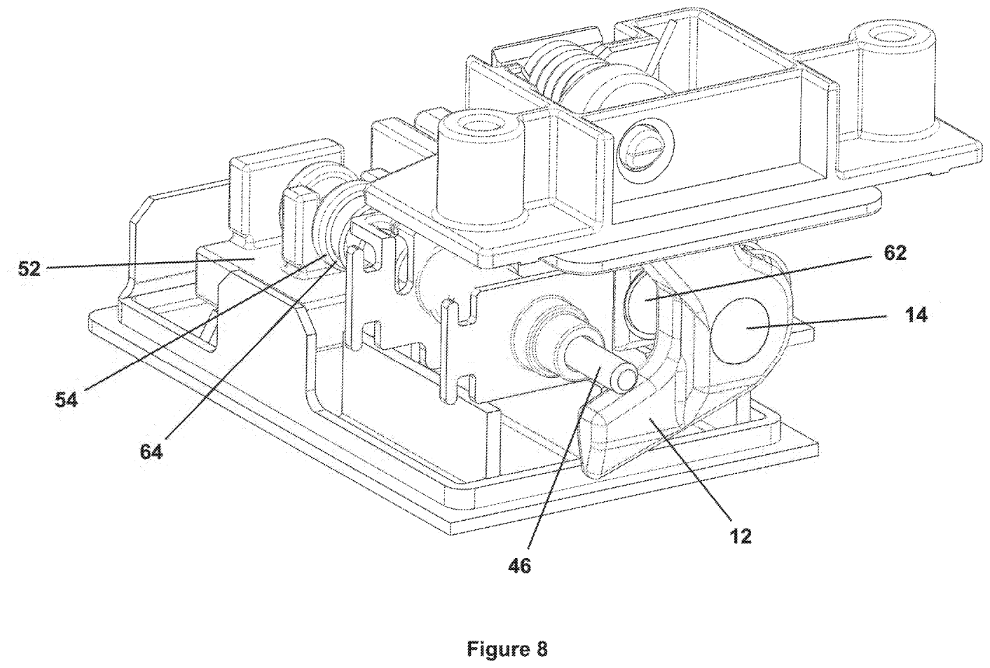

With reference now to FIG. 7, the locking pin 46 is shown in a retracted, or unlocked, position. This unlocked position is defined by the locking pin 46 being retracted such that the pawl arm 12 can pass freely through that area which would otherwise be occupied by the locking pin 46 when in the extended position. Conversely, with reference to FIG. 8, the locking pin 46 is shown in an extended, or locked, position. This locked position is defined by the locking pin 46 being in an extended position such that the movement of the pawl arm 12 is restricted by the position of the locking pin 46.

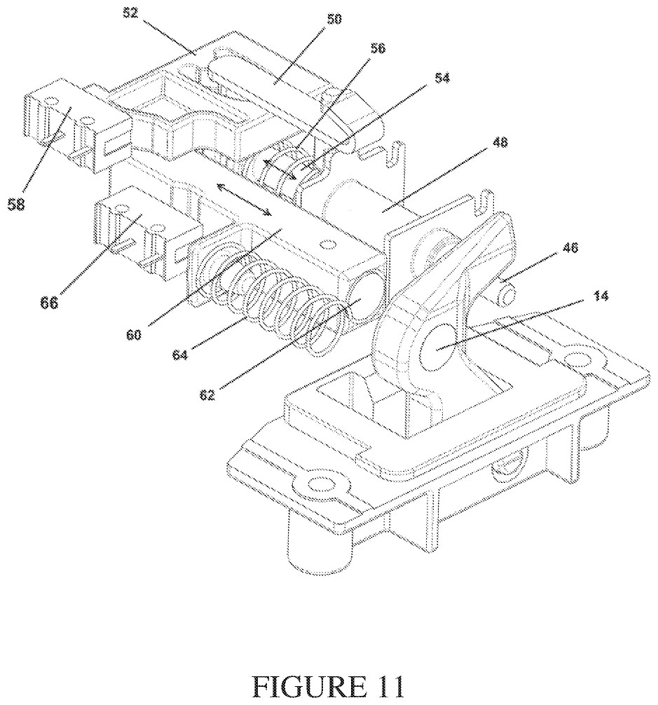

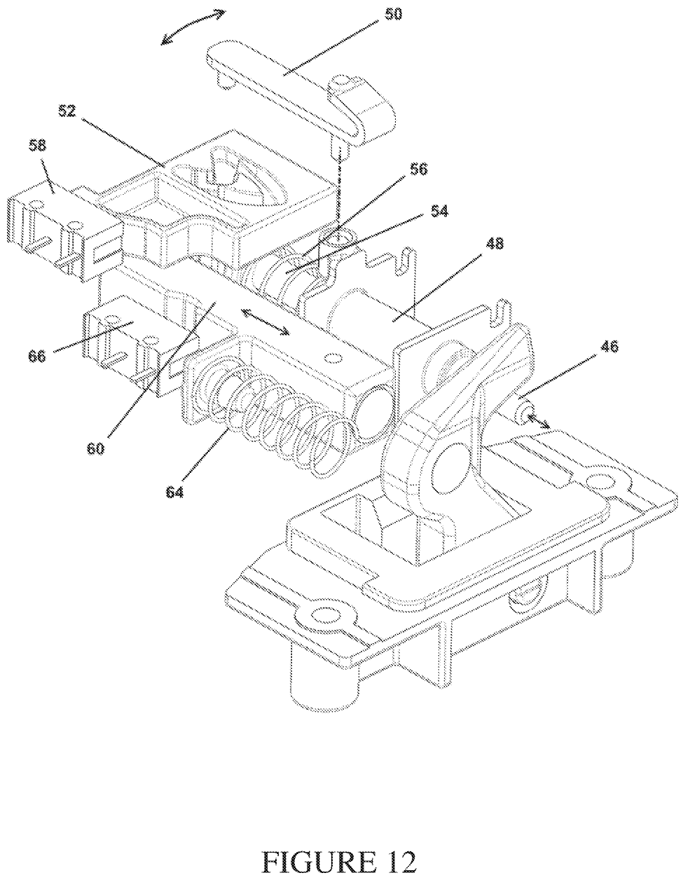

With reference now to FIGS. 11 and 12, an inverted view of the locking mechanism 40 is shown wherein the locking pin 46 is in an extended, or locked, position with the pawl mechanism 10 in place. The locking mechanism 40 is spring biased when placed in a retracted, or locked, position. As the appliance lid or door closes, the pawl magnet 14 acts upon slide magnet 62 to actuate switch slide 60, in turn pulling the slide toward the pawl magnet 14 and thus actuating the lid sensor switch 66. With switch 66 actuated, the appliance controller can proceed with momentarily activating solenoid 48, which actuates the plunger 54, the labyrinth block 52, and the locking pin 46. This linear actuation of the plunger 54, labyrinth block 52, and locking pin 46 manipulates the plunger cam 50 to a locking position in the labyrinth block 52, thus holding the locking pin 46 in an extended and locked position. Further, the labyrinth block 52 actuates the lock switch 58 to allow the appliance controller to proceed with the selected function. Upon completion of the appliance function, the appliance controller will momentarily reactivate the solenoid 48 to release the plunger cam 50 from the labyrinth block 52 locked position and allow the plunger biasing spring 56 to retract the plunger 54, labyrinth block 52, and locking pin 46 such that the lid or door of the associated appliance can be opened. When the lid or door is opened, the distance between the pawl magnet 14 and the slide magnet 62 increases, thus resulting in the attracting forces of the two magnets to diminish, thereby allowing the sensor slide biasing spring 64 to move away from the pawl magnet 14 and deactivate the lid sensor switch 66.

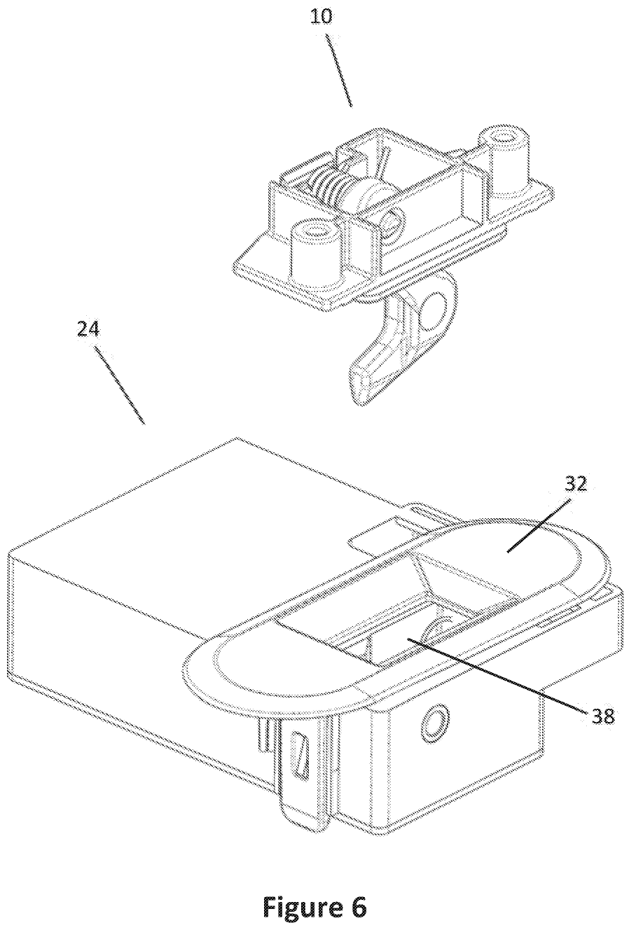

With reference now to FIG. 6, the lock mechanism 40 is shown encapsulated in the housing assembly 24, with the housing assembly 24 having the bezel 32 affixed thereto. The contents of the lock mechanism, when encapsulated by the housing assembly 24, are thus completely hydrophobically sealed from the outside environment. The combination of the receiving channel 30 and receiving channel slot 38, which resemble a cavity or opening within that of the housing assembly 24, are such that they keep the internal contents of the lock mechanism 40 free from all sources of moisture, such as water, steam, condensation, or the like.

With continued reference to FIG. 6, when the pawl mechanism 10 is inserted into the receiving channel 30 and receiving channel slot 38 of the housing assembly 24, the pawl magnet 14 interacts with that of the lid sensor magnet 62. This magnetic interaction sends a signal to the programmable controller (not shown), indicating that the associated appliance is in the closed position. When in the closed position, the appliance is then capable of being activated for use according to the parameters of the associated appliance. For example, where the appliance is a washing machine, a rinse cycle may be commenced. Upon activation of the appliance, the programmable controller may send an electric signal which activates the solenoid 48. Upon causing the solenoid to actuate, the locking mechanism 40 may be placed in the locked position, whereby the locking pin 46 extends outward towards the opposing end of the housing assembly 24. When in the locked position, the pawl arm 12 becomes obstructed by the locking pin 46, thus causing the pawl mechanism to be unable to be withdrawn from that of the housing assembly 24.

During a force open event, the locking pin 46 stays in the locked, or extended, position. However, the magnetic relationship between the pawl magnet 14 and slide magnet 62 is altered, as the distance therebetween is suddenly increased, with such a change allowing the slide 60 to return via the force of the slide spring 64, thus deactivating the lid sensor switch 66. This in turn signals an open circuit state to the controller, shutting off any function of the appliance. Due to the protruding feature of pawl arm 12, the lid or door of the associated appliance cannot reclose completely because the locking pin 46 obstructs the path of the pawl arm 12 from reentering the locking mechanism 40. Consequently, the open circuit state of the lid sensor switch 66 precludes the appliance from functional use without first repairing or resetting the lock mechanism to an unlocked state.

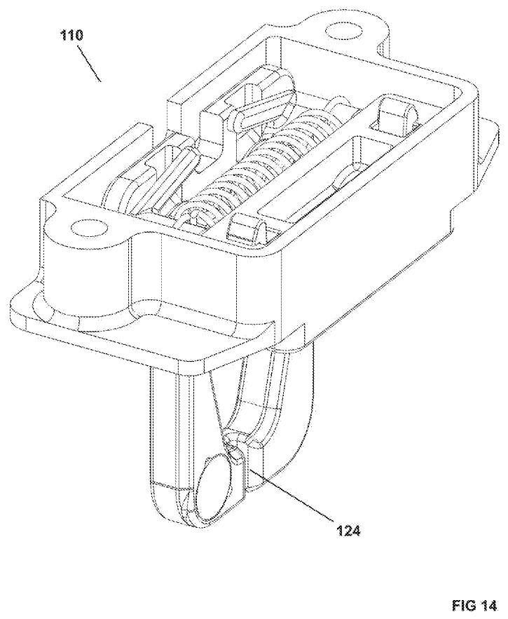

FIGS. 14-41 depict alternate embodiments of a lid lock assembly 100 according to the present invention. It is to be understood and appreciated that similarly named components in these alternate embodiments have similar functions to those in the aforementioned embodiments described hereinabove.

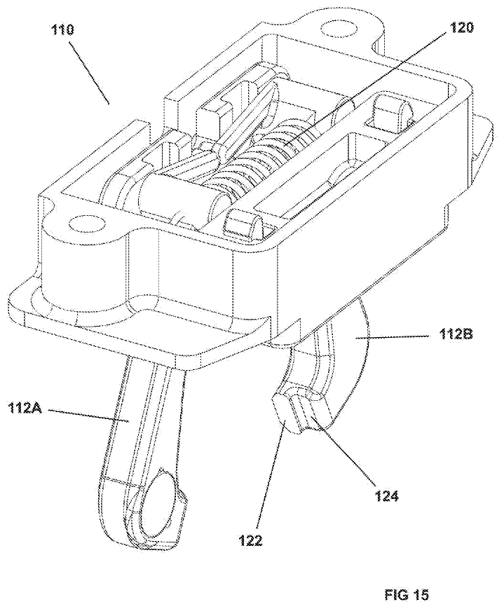

FIG. 14 shows an alternative type lid pawl assembly 110 having a pawl groove 124. The similar view of FIG. 15 shows the lid pawl assembly 110 and the pawl groove 124 with a lid pawl 112 in a broken condition caused by a forced open lid event. The pawl groove 124 is designed to cause the lid pawl 112 to fail at the pawl breakage area 122 when the lid is forced open, resulting in the lid pawl 112 being pulled over the locking pin 170, described in greater detail hereinbelow. The lid pawl 112 is thus designed to break into two distinct pawl segments 112A, 112B that are designed to spread apart from force induced by the pawl spring 120 when broken.

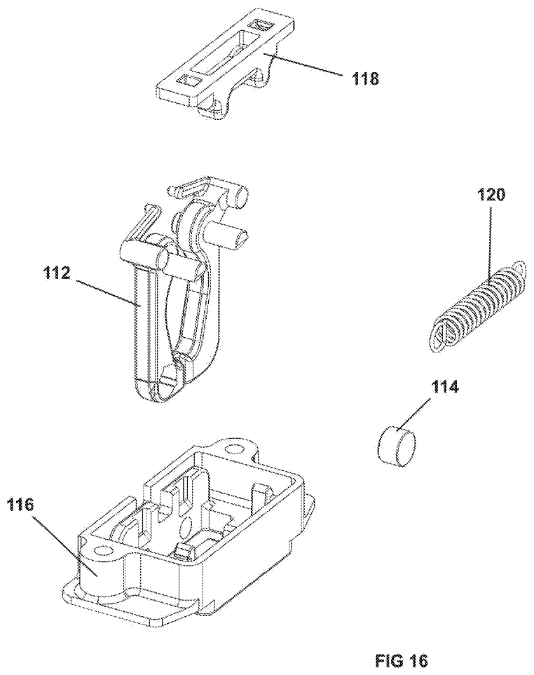

FIG. 16 is an exploded view of the lid pawl assembly 110. The lid pawl 112 has an aperture for receiving a lid pawl magnet 114. The pawl spring 120 is a coil spring for biasing the lid pawl 112 into a closed position. The pawl 112 is received into a lid pawl housing 116 and secured into place with a lid pawl retainer 118.

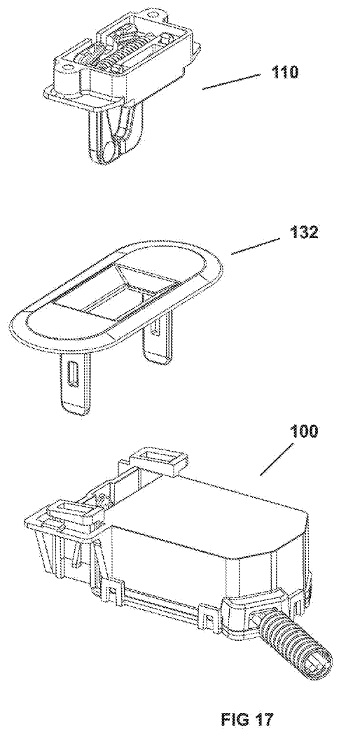

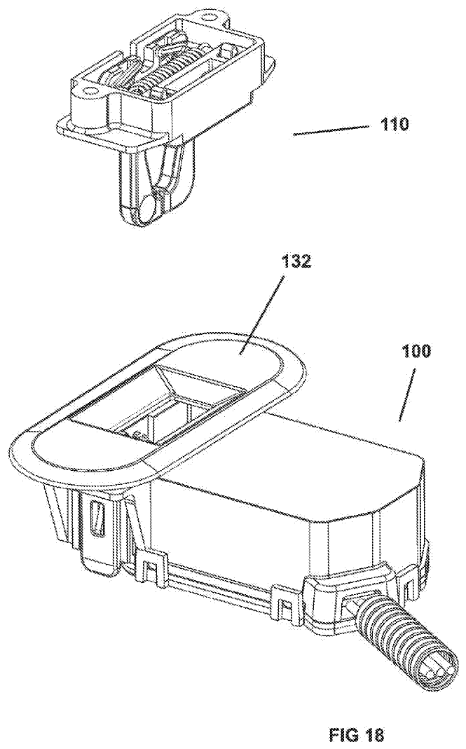

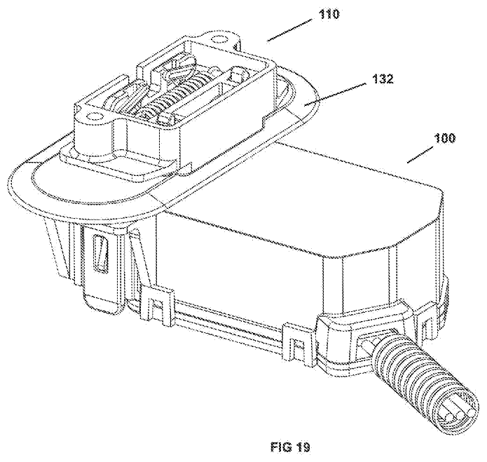

FIG. 17 is an exploded view showing a lid lock assembly 100 with a mounting bezel 132 and the lid pawl assembly 110. FIG. 18 shows the mounting bezel 132 snapped onto the lid lock assembly 100 for the purpose of attaching the lock assembly 100 to the top of a washing machine (not shown) and the lid pawl assembly 110. FIG. 19 shows the lid pawl assembly 110 engaged with the lid lock assembly 100. In the preferred embodiment, the lid lock assembly 100 is attached to the appliance body (e.g., a washing machine) and the lid pawl assembly 110 is attached to the appliance lid.

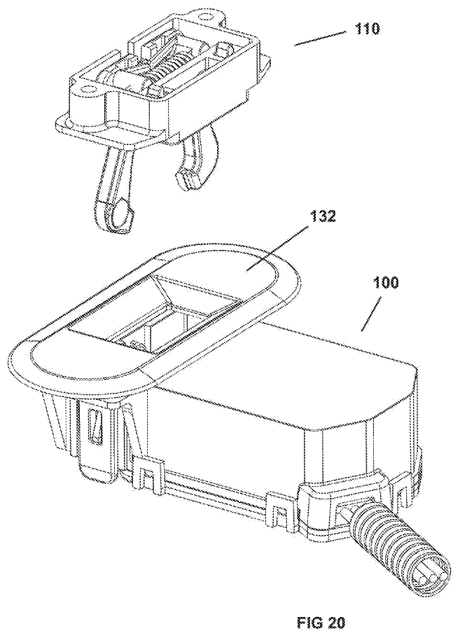

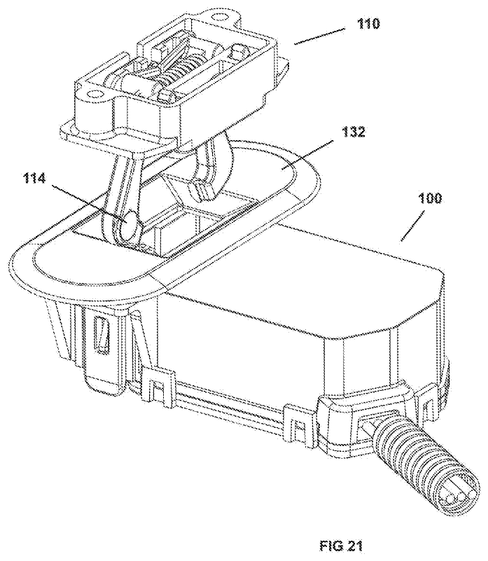

FIG. 20 depicts the lid pawl assembly 110 in the forced open, broken pawl condition. FIG. 21 shows the lid pawl assembly 110 in a forced open, broken pawl condition showing that the washing machine lid cannot be closed for operation, thus rending the machine inoperable because the lid pawl magnet 114 cannot be moved to an aligned position with the actuator magnet 156. In this state, the lid switch 230 is not actuated and the control circuit is open.

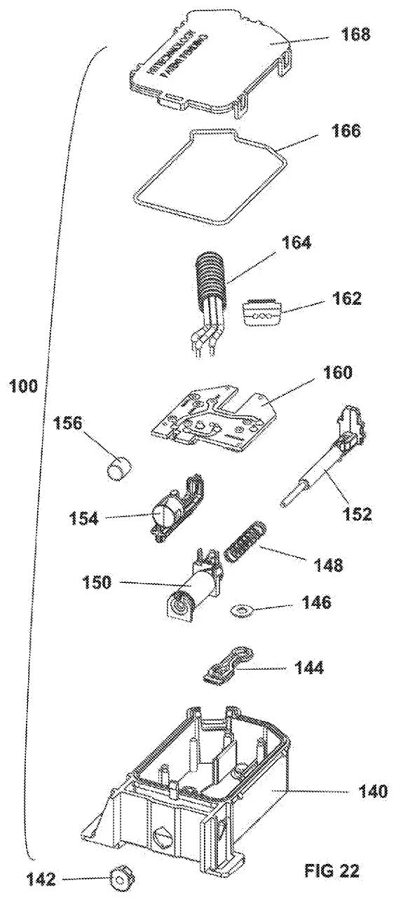

FIG. 22 is an exploded view of components of the lid lock assembly 100 in accordance with the alternative embodiment of the present invention. A housing 140 is enclosed by a cover 168 and sealed with a cover gasket 166. A locking toggle 144 is received in the housing 140 and retained in place with a retainer washer 146. A solenoid coil 150 engages a plunger spring 148 and is displaced using a solenoid plunger 152. The plunger 152 engages a bushing 142 that is retained in a side wall of the housing 140. As also shown in the exploded view of FIG. 22, a switch actuator assembly 154 receives the actuator magnet 156 and connects to a circuit board assembly 160. A wire harness 164 connects to the circuit board assembly 160 and engages the housing 140 with a wire grommet 162.

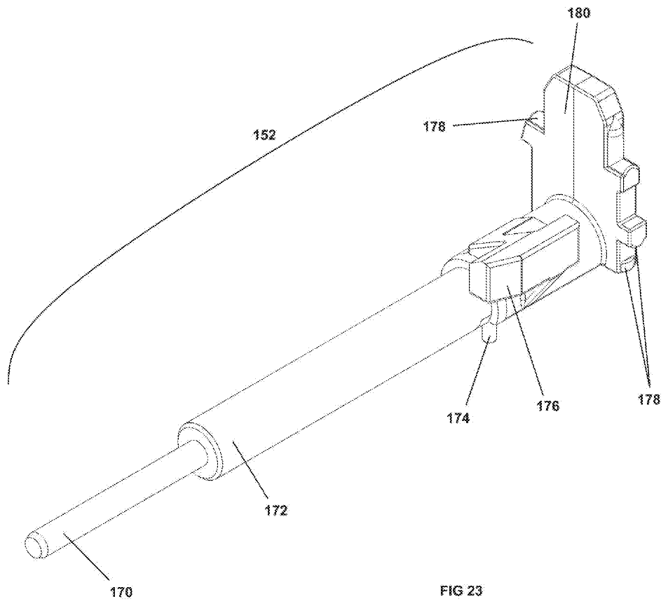

FIG. 23 shows the components of the solenoid plunger 152, including a locking pin 170 and a plunger core 172, which are aligned longitudinally along an axis of the solenoid plunger 152. A toggle pin 174 extends downwardly, in a direction perpendicular to the axis of the solenoid plunger 152, for engagement with the toggle labyrinth 182, as explained hereinbelow. A switch cam 176 is mounted along a top of the solenoid plunger 152. A plunger back support 180 is at an opposite end of the solenoid plunger 152 from the locking pin 170, and includes a plurality of plunger back guide surfaces 178.

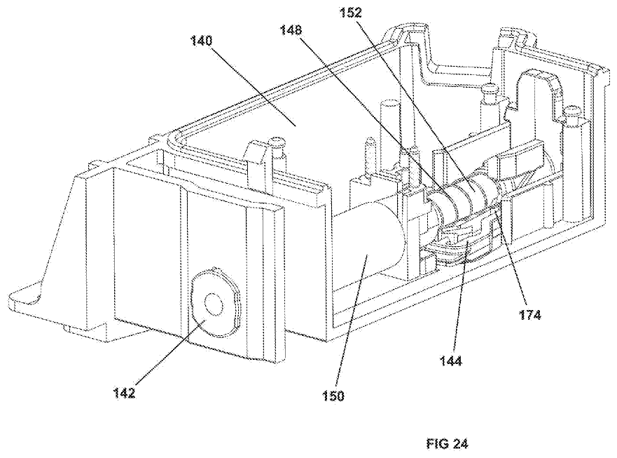

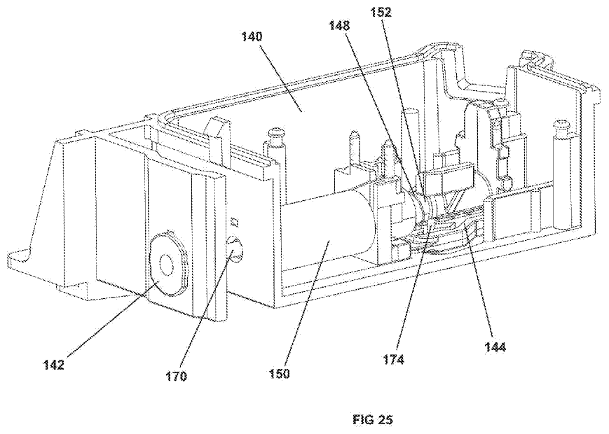

FIG. 24 shows the solenoid coil 150 and plunger spring 148 engaged with the solenoid plunger 152 retained in the housing 140 in the unlocked position. The toggle pin 174 is engaged with the locking toggle 144 in the unlocked position within the toggle labyrinth 182. FIG. 25 also shows the solenoid coil 150, plunger spring 148, and solenoid plunger 152 displaced into the locked position, with the locking pin 170 engaging lid pawl 112 as described hereinabove, and penetrating the bushing 142 on the housing 140 to retain the lid pawl 112 securely in place. The toggle pin 174 is in a different position within the toggle labyrinth 182 of the locking toggle 144 when in the locked position, as will be explained in greater detail hereinbelow.

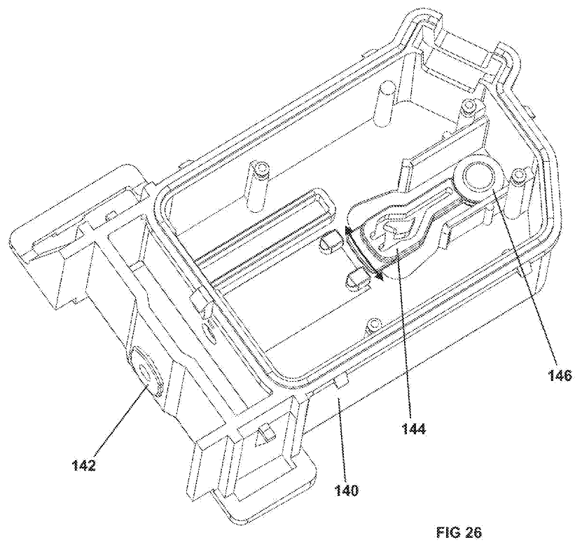

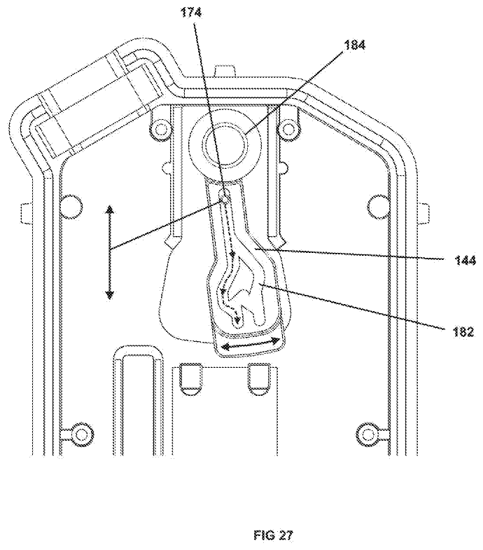

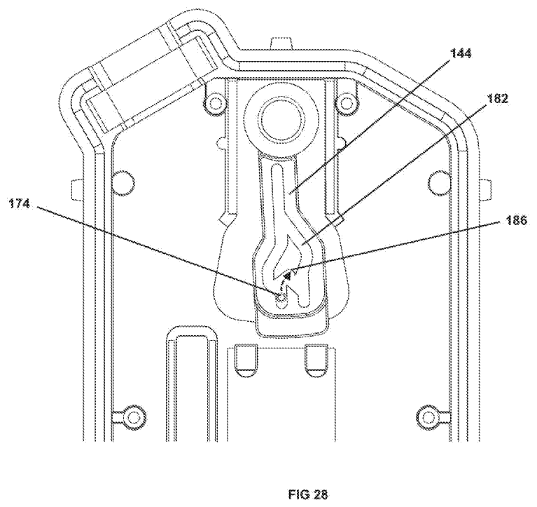

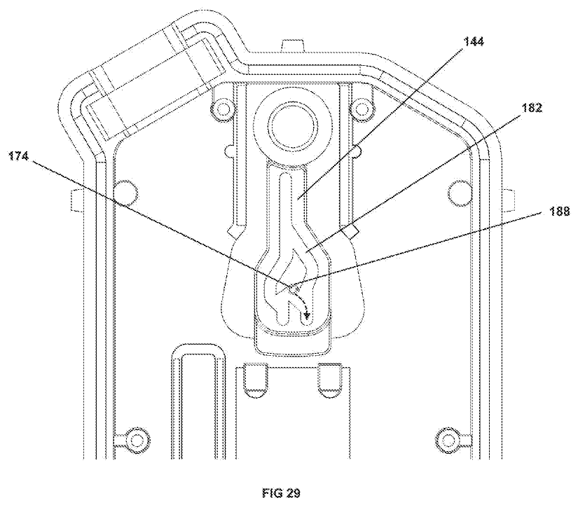

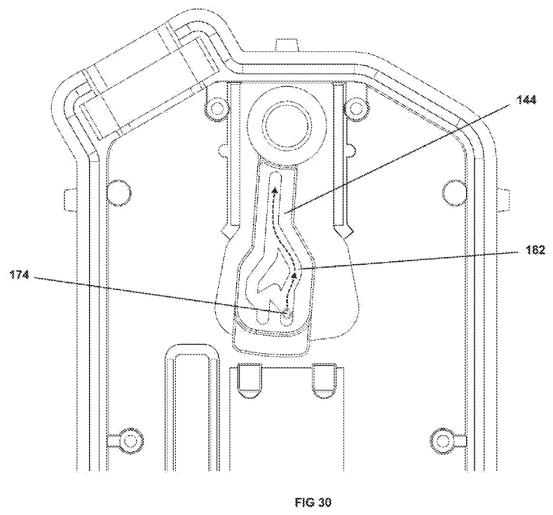

FIG. 26 shows the lock housing 140 with the locking toggle 144 retained therein with the retainer washer 146. This view shows the side-to-side pivotal motion of the locking toggle 144 as the toggle pin 174 moves through the toggle labyrinth 182. FIG. 27 is an overhead view of the locking toggle 144 with the toggle pin 174 in a position within the toggle labyrinth 182 indicative of the unlocked state. The overhead view of FIG. 28 shows the locking toggle 144 with the toggle pin 174 in transition to a locked state. FIG. 29 shows the position within the locking toggle 144 of the toggle pin 174 cradled within the locking niche 188, which is the locked position, so that the state of the lock is locked. FIG. 30 shows the locking toggle 144 with the toggle pin 174 within the toggle labyrinth 182 in transition to an unlocked state.

The movement of the toggle pin 174 through the toggle labyrinth 182 of the locking toggle 144 is effected by displacement of the solenoid plunger 152 by the solenoid coil 150. The toggle labyrinth 182 is configured so that back-and-forth, reciprocating motion of the solenoid plunger 152 moves the toggle pin 174 in a sequential path along the toggle labyrinth 182 through the states indicated in FIGS. 27-30. The locking toggle 144 pivots in the side-to-side motion indicated in FIG. 26 as the solenoid plunger 152 moves in its back-and-forth, reciprocating motion as the toggle pin 174 traces its path through the toggle labyrinth 182.

In this manner, the solenoid plunger 152 is in the position indicated in FIG. 24 when the toggle pin 174 is in the position indicated in FIG. 27. The solenoid plunger 152 is displaced in the direction indicated by FIG. 25 when the toggle pin 174 is moved through the toggle labyrinth 182 into the first transition path indicated in FIG. 28. Another displacement of the solenoid plunger 152 toward the direction of FIG. 24 moves the toggle pin 174 into the locked position within the locking niche 188 as shown in FIG. 29. Another displacement of the solenoid plunger 152 toward the direction of FIG. 25 moves the toggle pin 174 along the second transition path of FIG. 30 to return the toggle pin 174 to the original unlocked position of FIG. 27.

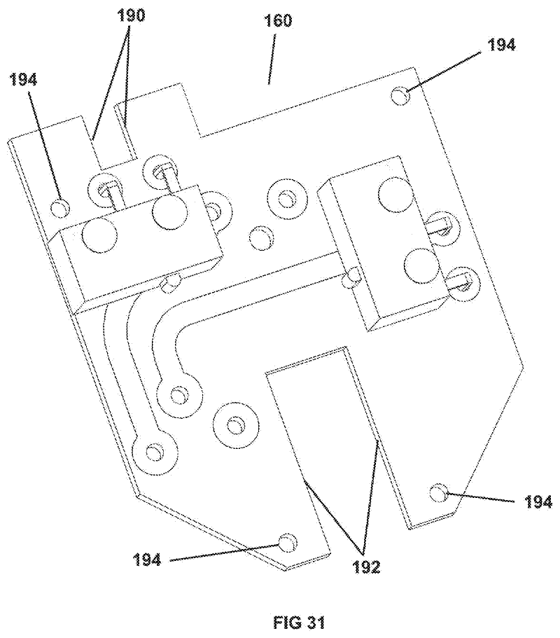

FIG. 31 is a view of the circuit board assembly 160 for actuating the solenoid coil 150 for displacing the solenoid plunger 152. The circuit board assembly 160 includes an actuator guide slot 190 for guiding the switch actuator assembly 154, which will be further discussed hereinbelow. Also included is a plunger guide slot 192 for guiding the plunger back support 180, as particularly indicated in FIG. 23. Circuit board mounting holes 194 are used for affixing the circuit board assembly 160 to the housing 140.

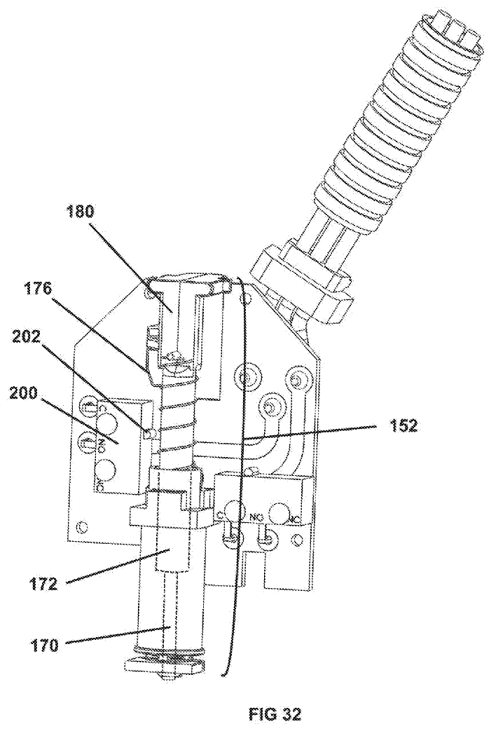

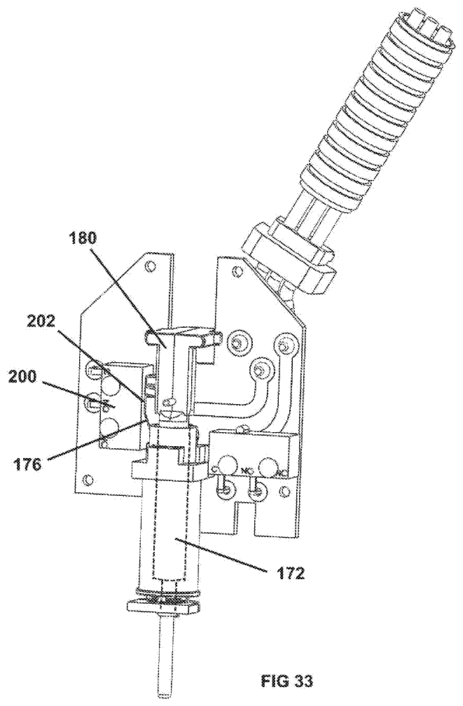

FIG. 32 shows the solenoid plunger 152 in the unlocked position with respect to the circuit board assembly 160. The plunger back support 180 is at the top of the plunger guide slot 42. The solenoid plunger 152 includes a switch cam 176 that interacts with a lock switch 200 having a lock switch button 202. FIG. 33 shows the solenoid plunger 152 displaced into the locked position. The switch cam 176 is moved to a position where it engages the lock switch 200 so that the lock switch button 202 is depressed. The switch button 202 thus sends a signal to the system indicating a locked state.

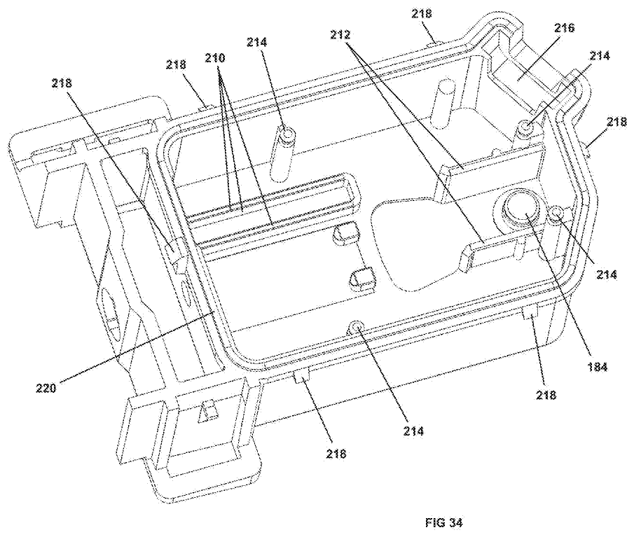

FIG. 34 is a detailed view of featured found on the lock housing 140. A toggle pivot 184 supports the locking toggle 144, as explained hereinabove. Actuator guide rails 210 guide the movement of the switch actuator assembly 154, as will be explained hereinbelow. Plunger guide rails 212 guide and support the plunger back support 180 for reciprocating movement. Circuit board mounting bosses 214 provide for a structure for attaching the circuit board assembly 160. A grommet retaining groove 216 retains the wire grommet 162. Housing snaps 218 engage cover snaps 224 on the cover 168. A gasket compression rib 220 engages with the cover gasket 166.

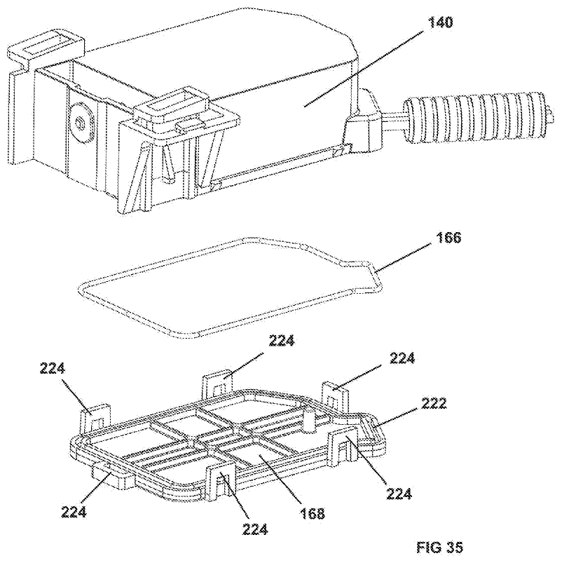

The exploded view of FIG. 35 shows the lock housing 140 with the gasket 166 and cover 168 having a gasket groove 116 for receiving and retaining the gasket 166, providing sealing of the electronic components against a moist environment. The cover snap features 224 are shown, which engage the housing snaps 218, as had been indicated in FIG. 18.

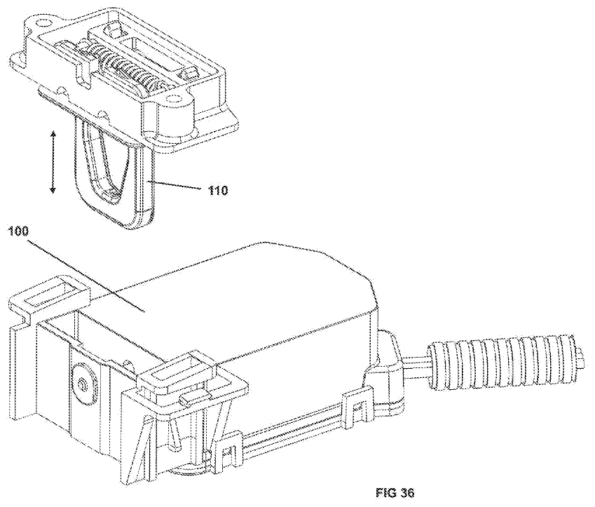

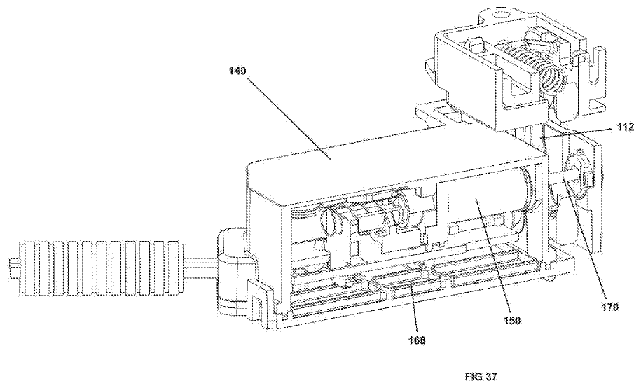

FIG. 36 is an alignment illustration of the lock assembly 100 in accordance with the alternate embodiments, further including an alternate style pawl assembly 110. The cut-away view of FIG. 37 shows the solenoid coil 150 inside the lock housing 140 with the cover 168 in place and the lid pawl 112 in the engagement position. The locking pin 170 is shown in the locked position where it engages and retains the lid pawl 112.

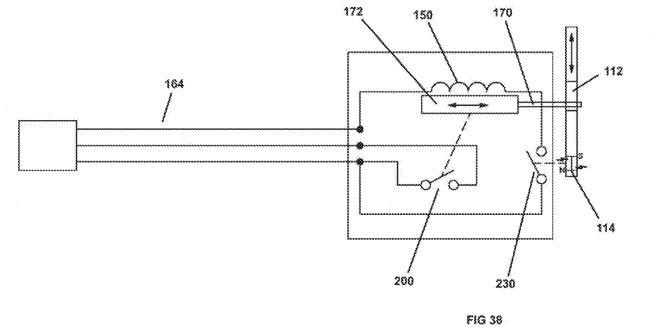

FIG. 38 is an electrical schematic showing circuit logic and symbolic references for the to the solenoid plunger core 172 with locking pin 170, residing within the solenoid coil 150. As indicated, the locking pin 170 is in the locked position and engaged with the lid pawl 112. The lock sensing switch 200 detects the locked position. The lid sensing switch 230 detects the presence of the pawl magnet 114, as will be further explained hereinbelow.

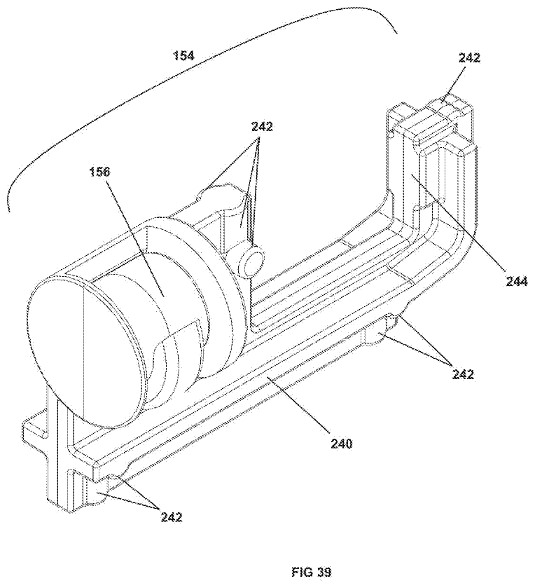

FIG. 39 illustrates details of the switch actuator assembly 154. The switch actuator body 240 retains the actuator magnet 156. The switch actuator 240 has multiple actuator guide surfaces 242 that move back and forth within the actuator guide rails 210 in the housing 140. Also included is a switch actuator surface 244 that engages the lid switch 230.

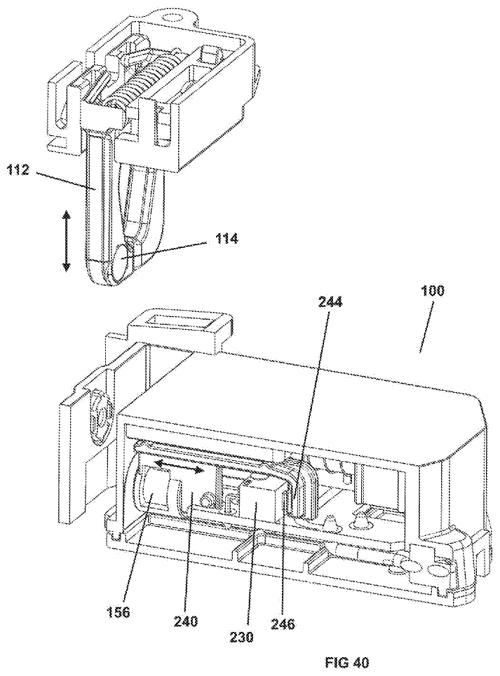

FIG. 40 shows the interface of the lid pawl 112 with the lid lock assembly 100. The lid pawl 112 is shown in a non-engaged position, indicating that the lid is open and the appliance is thereby deactivated. Before the pawl 112 is lowered into position, the lid pawl magnet 114 has no influence on switch actuator magnet 156. The switch actuation surface 244 of the switch actuator 240 does not engage with the lid switch 230 and the lid switch button 246 is not yet depressed.

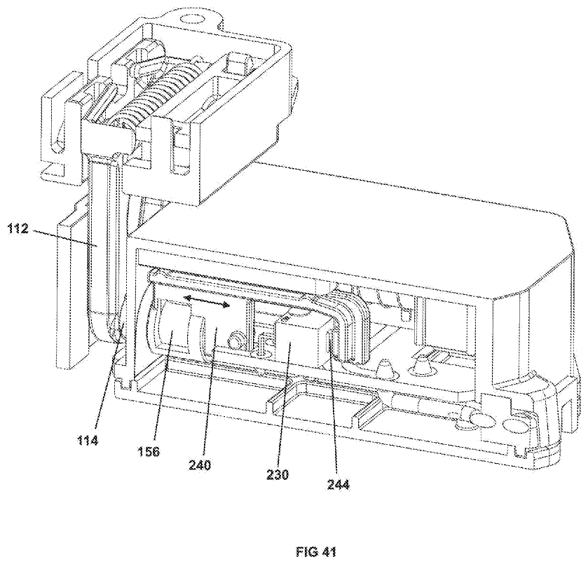

As shown in FIG. 41, the lid pawl 112 is lowered into the lid lock assembly 100 so that the lid pawl magnet 114 has a magnetic attraction influence on the switch actuator magnet 156, being magnetically drawn to the lid pawl magnet 114, thereby displacing the switch actuator 240 so that the switch actuation surface 244 is brought into engagement with the lid switch 230, causing the lid switch button 246 to be depressed, thereby sending a signal to the system that the lid pawl 112 is engaged. This signal enables the appliance to be activated. In accordance with other views described hereinabove, the locking pin 170 is now engaged, retaining the lid pawl 112 unless and until the lid is forcibly opened, which breaks the pawl, rendering the appliance inoperable.

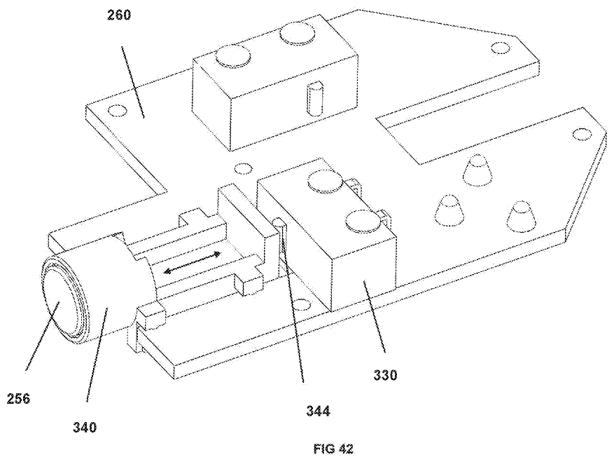

FIGS. 42-46 depict further alternate embodiments of a lid lock assembly according to the present invention. The alternate embodiments of these figures depict a different manner of switch actuation than the embodiments shown in FIGS. 14-41 but are otherwise structurally the same as the device described and depicted in those aforementioned embodiments. It is to be understood and appreciated that similarly named and illustrated components in these further alternate embodiments have similar functions to those in the aforementioned embodiments described hereinabove.

FIG. 42 is a perspective view of a circuit board assembly 260 with a magnetic actuator for the appliance according to a further alternative embodiment. The circuit board assembly 260 includes a lid switch 330 mounted thereon. The lid switch 330 includes a lid switch button 344. A sliding switch actuator 340 is configured for sliding back and forth in a reciprocal motion within the circuit board assembly 260. The sliding switch actuator 340 is aligned for engagement with the lid switch button 344 when in an actuation position. The sliding switch actuator 340 receives and retains a switch actuator repelling magnet 256 for engaging the lid pawl 312, as described in detail hereinbelow.

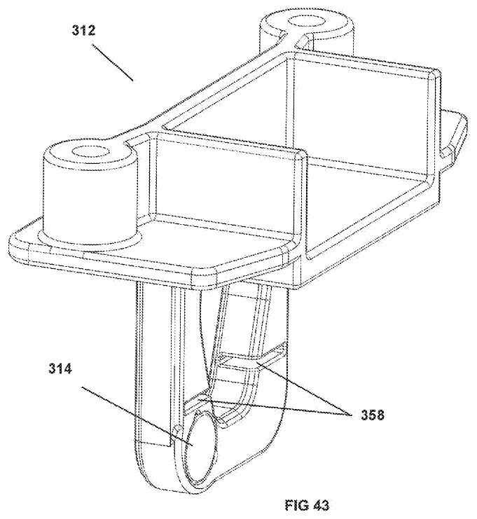

FIG. 43 is a perspective view of a lid pawl 312 that receives and retains a lid pawl repelling magnet 314. This alternate construction of the lid pawl 312 is formed of a single molded component that retains the lid pawl repelling magnet 314 installed with a like pole configured to repel the like pole of the switch actuator repelling magnet 256 when engaged in the lock housing. The respective magnets 314, 256 are configured to repel each other when the lid pawl 312 is moved into an actuation zone of the locking mechanism.

In this further alternative embodiment shown in FIG. 43, the lid pawl 312 includes a pawl breakage area defined by two grooves 358 that represent tapered, frangible portions. The two grooves are designed to break from contact between the lid pawl 312 and the locking pin 170 in the event of a forced open lid or door, as described hereinabove.

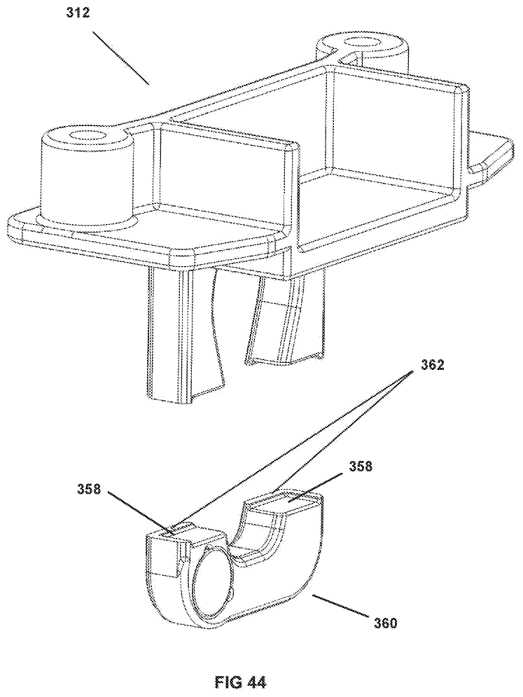

FIG. 44 is a perspective view showing a lid pawl 312 in a broken condition resulting from breakage from the locking pin 170 resulting from a forced open lid or door, as described hereinabove. In the broken condition the lid pawl 312 includes a detached lower portion 360 that is broken off from the lid pawl 312. The detached lower portion 360 includes breakage along broken surfaces 362 adjoining the grooves 358. The detached portion 360 of the lid pawl 312 is designed to break off and fall harmlessly to the floor, taking the lid pawl repelling magnet 314 with it. In this situation, the sliding switch actuator 340 cannot engage the lid switch 330, and the lid switch button 344 cannot be actuated. Thus, the broken condition of the lid pawl 312 renders the appliance inoperable.

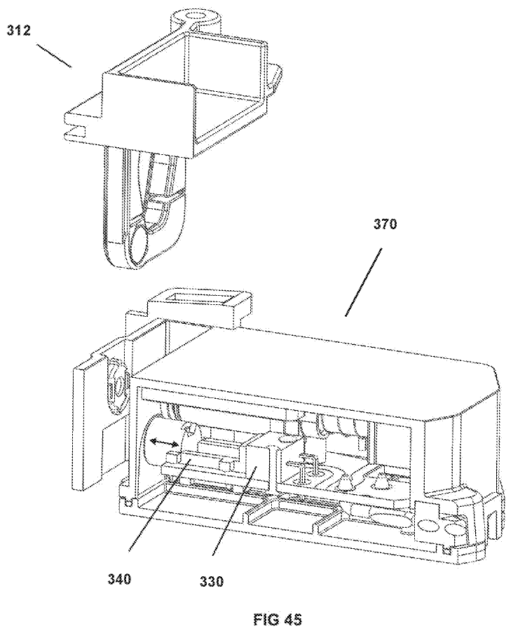

FIG. 45 is a perspective view depicting the interface of the lid pawl 312 and a locking mechanism 370 in accordance with the further alternate embodiment. The lid pawl 312 having the lid pawl repelling magnet 314 is shown in a “lid open” position with respect to the locking mechanism 370. FIG. 45 also includes a cutaway view showing the sliding switch actuator 340 and the lid switch 330. In the “lid open” position, the sliding switch actuator 340 does not engage the lid switch 330. Thus, the lid switch button 344 is not depressed resulting from engagement with the sliding switch actuator 340 and the appliance will not operate.

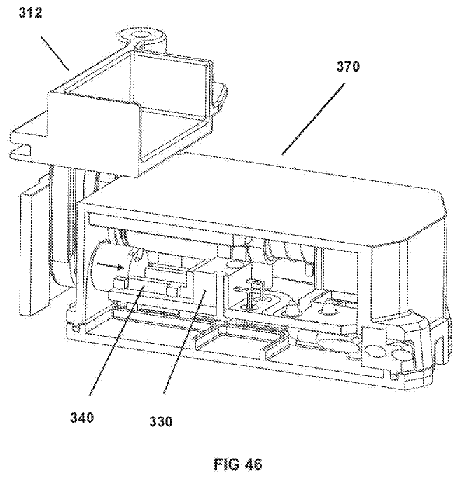

FIG. 46 is a perspective view depicting the interface of the lid pawl 312 and the locking mechanism 370 in accordance with the further alternate embodiment. The lid pawl 312 having the lid pawl repelling magnet 314 is shown in a “lid closed” position with respect to the locking mechanism 370. FIG. 46 also includes a cutaway view showing the sliding switch actuator 340 engaging the lid switch 330 in the “lid closed” position. The lid pawl repelling magnet 314 is thus brought into proximity in the actuation zone with the switch actuator repelling magnet 256.

The resulting magnetic repulsion from the two like poles of the respective magnets 256, 314 facing each other causes the sliding switch actuator 340 to slide into engagement with the lid switch 330, into the actuation position with the lid switch button 344, and thereby depressing the lid switch button 344. This indicates to the system that that the lid pawl 312 is engaged, thus completing the circuit for appliance operation, thereby allowing the appliance to operate. This action causes the solenoid coil 150 to displace the solenoid plunger 152 and thereby moving the locking pin 170 into engagement with the lid pawl 312 in the manner described hereinabove.

As described hereinabove, the present invention employs magnetic repulsion to actuate the switch, contrary to magnetic attraction as commonly used in prior art reed switches. Magnetic repulsion is found to be a safer mode of switch actuation than attraction since it precludes a magnet or piece of ferrous metal to be used to actuate the switch by attraction of the magnet within the lock housing, to thereby defeat the function of the locking mechanism. Consequently, it is not easy or intuitive for a user to defeat the locking mechanism with another magnet or a piece of ferrous material.

Numerous embodiments have been described by the present disclosure. It will be apparent to those skilled in the art that the above methods and apparatuses may incorporate changes and modifications without departing from the general scope of this disclosure. It is intended to include all such modifications and alterations in so far as they come within the scope of the appended claims or the equivalents thereof.

Having thus described the appliance lock disclosed herein, it is now claimed:

What is claimed:

1. An appliance lock comprising:
a lid pawl as a latch for a lid of an appliance, for restricting movement of the lid of the appliance, wherein the lid pawl receives and retains a lid pawl repelling magnet;
a sliding switch actuator configured for sliding back and forth in a reciprocal motion, wherein the sliding switch actuator receives and retains a switch actuator repelling magnet, such that the lid pawl repelling magnet and the switch actuator repelling magnet are configured with like poles in a facing relationship to repel each other when the lid pawl is moved into an actuation zone; and
a lid switch including a lid switch button, wherein magnetic repulsion from the two like poles of the respective switch actuator repelling magnet and the lid pawl repelling magnet facing each other moves the sliding switch actuator into an actuation position with the lid switch button, thus completing the circuit for appliance operation, thereby allowing the appliance to operate.

2. The appliance lock of claim 1, further comprising a circuit board assembly upon which the lid switch is mounted and within which the sliding switch actuator is configured for sliding back and forth in a reciprocal motion.

3. The appliance lock of claim 1, wherein the lid pawl is formed as a single molded component.

4. The appliance lock of claim 1, wherein the lid pawl comprises a pawl breakage area such that a detached lower section of the pawl breaks off when the lid is forced open, being pulled over a locking pin.

5. The appliance lock of claim 4, wherein the pawl breakage area comprises two grooves that represent tapered, frangible portions that break from contact between the lid pawl and the locking pin in the event of a forced open lid.
